(19) United States
(12) Patent Application Publication
(10) Pub. No.: US 2024/0187087 A1
(43) Pub. Date: Jun. 6, 2024

(54) METHOD FOR ALLOCATING TIME-FREQUENCY RESOURCES IN A SATELLITE TELECOMMUNICATION SYSTEM USING BEAMFORMING, AND ASSOCIATED DEVICE AND COMPUTER PROGRAM

(71) Applicant: THALES, MEUDON (FR)

(72) Inventors: Mathieu ARNAUD, TOULOUSE (FR); Benjamin BAUDRY, TOULOUSE (FR); Mohamed EL JAAFARI, TOULOUSE (FR); Baptiste CHAMAILLARD, TOULOUSE (FR)

(21) Appl. No.: 18/522,127

(22) Filed: Nov. 28, 2023

(30) Foreign Application Priority Data
Dec. 6, 2022 (FR) 2212806

(51) Int. Cl. H04B 7/185; H04B 7/06

(52) U.S. Cl. CPC H04B 7/18513; H04B 7/0617

(57) ABSTRACT

A method for allocating time-frequency telecommunication resources in a telecommunication system includes a satellite, user terminals UE (20_1, 20_2), the satellite simultaneously rendering multiple telecommunication beams (B_1, B_2) that are each associated with a separate user terminal UE (20_1, 20_2) and dynamically re-centering each beam on the associated UE; the method comprising: given a set of grids each representing at least a portion of the Earth's surface and each comprising a plurality of areas, the distance between any two areas of a grid being above a determined non-zero threshold associated with the grid, the time-frequency resources are allocated relative to a time T by applying at least the following rule: a time-frequency resource associated with the grid may be allocated to each of 2 UEs (20_1, 20_2) only if the positions of the 2 UEs are in separate areas of the grid.

### CROSS-REFERENCE TO RELATED APPLICATION

This application claims priority to foreign French patent application No. FR 2212806, filed on Dec. 6, 2022, the disclosure of which is incorporated by reference in its entirety.

### FIELD OF THE INVENTION

The invention pertains to the field of satellite telecommunications.

### BACKGROUND

More precisely, the invention relates to satellite telecommunication systems rendering an MF-TDMA (Multi-Frequency and Time-Division Multiple Access) or OFDM (Orthogonal Frequency Division Multiplexing) waveform based on single-user elementary resources (also referred to as block resources), a digital payload with beamforming capabilities to dynamically center each of the telecommunication radio frequency beams on the user terminal (UE, User Equipment) selectively associated with the beam, for example in satellite systems rendering telecommunications according to the 4G or 5G New Radio Non Terrestrial Network (5G NR NTN) standard.

More specifically, the invention relates to a method for allocating time-frequency telecommunication resources in a wireless satellite telecommunication system,

said wireless satellite telecommunication system comprising a satellite, user terminals UE, the satellite being suitable for simultaneously rendering multiple telecommunication beams that are each associated with a separate user and for dynamically centering each beam on the associated UE;
each telecommunication beam being established according to time-frequency resources selectively allocated to the UE associated with the beam.

The time-frequency resources in 5G NR NTN telecommunications are organized, in a known manner, in the form of blocks of elementary resources selectively allocated by a scheduler module to interchanges with a UE. In the time domain, the resource is divided into OFDM symbols/slot (1 slot=temporal succession of 14 symbols)/subframe/frame (see FIG. 6). When it allocates resources to a UE, a “planner” module decides on an allocation in terms of PRBs (Physical Resource Blocks) for the frequency domain, and symbols and/or slots in the time domain.

If the beam management is not coordinated, there are times when the PRBs associated with two beams formed in directions that are too close give rise to interference levels that lead to an unacceptable degradation in reception throughput performance.

### SUMMARY OF THE INVENTION

To this end, according to a first aspect, the present invention describes a method for allocating time-frequency telecommunication resources in a wireless satellite telecommunication system,

said satellite telecommunication system comprising a satellite, user terminals UE, the satellite being suitable for simultaneously rendering multiple telecommunication beams that are each associated, at a given time, with a separate user terminal UE and for dynamically re-centering each beam on the UE associated with said beam;
each telecommunication beam being established according to time-frequency resources selectively allocated to the associated UE;
said method being characterized in that it comprises the following steps rendered by an electronic resource allocation unit:
obtaining the position of each UE;
given a set of grids each representing at least a portion of the Earth's surface and each comprising a plurality of non-contiguous areas distributed in the grid, the distance between any two areas of a grid being above a determined non-zero threshold associated with the grid, the time-frequency resources are allocated relative to a time T by applying at least the following rule, at least the same time-frequency resource being associated with the grid beforehand: said time-frequency resource associated with the grid may be allocated to each of 2 UEs only if the obtained positions of said 2 UEs are in separate areas from said plurality of non-contiguous areas distributed in the grid.

In some embodiments, such a method will moreover comprise at least one of the following characteristics:

if, during a first step of allocating time-frequency resources using said set of grids that are each associated with a first determined threshold, it has not been possible to allocate time-frequency resources to at least one UE in accordance with the rule, an additional allocation step is performed using at least one set of additional grid(s) representing at least said portion of the Earth's surface and each comprising a plurality of non-contiguous areas distributed in the grid, the distance between any two areas of a grid being above a second determined non-zero threshold associated with the grid, which is below the first threshold;

the time-frequency resources are allocated relative to a time T by moreover applying at least the following rule:
given a first grid, or a second grid separate from the first grid, from the set of grids associated with a first time-frequency resource, or a second time-frequency resource separate from the first time-frequency resource: when a UE is determined as being located in both a first area from said plurality of non-contiguous areas distributed in the first grid and a second area from said plurality of non-contiguous areas distributed in the second grid, it is determined whether the UE is closer to the center of the first area or to the center of the second area; and if the UE is determined as being closer to the center of the first area, or the second area, the first time-frequency resource, or the second time-frequency resource, is allocated thereto;

the position of a UE is obtained by rendering the following steps:
calculating values of the beamforming weights maximizing the power of predefined signals received from a UE;
estimating the direction of arrival, referred to as DOA, of a signal from a UE according to said beamforming weights determined for the UE by applying a regression algorithm linking beamforming weights and DOAs;
determining the position of the UE according to at least the intersection of the Earth's surface and the estimated DOA.

According to another aspect, the invention describes a computer program intended to be stored in the memory of an electronic unit for allocating resources in a wireless satellite telecommunication system comprising a satellite, user terminals UE, the satellite simultaneously rendering multiple telecommunication beams that are each associated with a separate user and dynamically re-centering each beam on the associated UE;

each telecommunication beam being established according to time-frequency resources selectively allocated to the associated UE; said time-frequency resource allocation unit moreover comprising a microcomputer;
said computer program comprising instructions that, when executed on the microcomputer, render the steps of a method according to the first aspect of the invention.

According to another aspect, the invention describes a device for allocating time-frequency telecommunication resources for a wireless satellite telecommunication system,

said satellite telecommunication system comprising a satellite, user terminals UE, the satellite being suitable for simultaneously rendering multiple telecommunication beams that are each associated, at a given time, with a separate user terminal UE and for dynamically re-centering each beam on the UE associated with said beam;
each telecommunication beam being established according to time-frequency resources selectively allocated to the associated UE;
said resource allocation device being characterized in that it is suitable for obtaining the position of each UE and, given a set of grids each representing at least a portion of the Earth's surface and each comprising a plurality of non-contiguous areas distributed in the grid, the distance between any two areas of a grid being above a determined non-zero threshold associated with the grid, for allocating the time-frequency resources relative to a time T by applying at least the following rule, at least the same time-frequency resource being associated with the grid beforehand: said time-frequency resource associated with the grid may be allocated to each of 2 UEs only if the obtained positions of said 2 UEs are in separate areas from said plurality of non-contiguous areas distributed in the grid.

In some embodiments, such a device will moreover comprise at least one of the following features:

the device is suitable for, if, during a first step of allocating time-frequency resources using said set of grids that are each associated with a first determined threshold, it has not been able to allocate time-frequency resources to at least one UE in accordance with the rule, performing an additional allocation step using at least one set of additional grid(s) representing at least said portion of the Earth's surface and each comprising a plurality of non-contiguous areas distributed in the grid, the distance between any two areas from said plurality of areas of a grid being above a second determined non-zero threshold associated with the grid, which is below the first threshold;

the time-frequency resource allocation device is suitable for allocating the time-frequency resources relative to a time T by moreover applying at least the following rule:
given a first grid, or a second grid separate from the first grid, from the set of grids associated with a first time-frequency resource, or a second time-frequency resource separate from the first time-frequency resource: when a UE is determined as being located in both a first area from said plurality of non-contiguous areas distributed in the first grid and a second area from said plurality of non-contiguous areas distributed in the second grid, it is determined whether the UE is closer to the center of the first area or to the center of the second area; and if the UE is determined as being closer to the center of the first area, or the second area, the first time-frequency resource, or the second time-frequency resource, is allocated thereto;

the time-frequency resource allocation device is suitable for obtaining the position of a UE by calculating values of the beamforming weights maximizing the power of predefined signals received from a UE, and then by estimating the direction of arrival, referred to as DOA, of a signal from a UE according to said beamforming weights determined for the UE by applying a regression algorithm linking beamforming weights and DOAs and by determining the position of the UE according to at least the intersection of the Earth's surface and the estimated DOA.

### BRIEF DESCRIPTION OF THE DRAWINGS

The invention will be better understood and other features, details and advantages will become more clearly apparent on reading the non-limiting description that follows, and by virtue of the appended figures, which are provided by way of example.

FIG. 1 is an illustration of a satellite telecommunication system in one embodiment of the invention;

FIG. 2 diagrammatically shows part of the reception processing chain of the satellite of the satellite telecommunication system of FIG. 1 in one embodiment of the invention;

FIG. 3 diagrammatically shows part of the transmission processing chain of the satellite of the satellite telecommunication system of FIG. 1 in one embodiment of the invention;

FIG. 4 illustrates steps of a time-frequency resource allocation method rendered in the satellite telecommunication system of FIG. 1 in one embodiment of the invention;

FIG. 5 shows a set of grids in one embodiment of the invention;

FIG. 6 illustrates the division of the time-frequency resource into slots of 14 OFDM and PRB symbols of 12 subcarriers respectively according to the frame numerology for the 5G NR standard;

FIG. 7 illustrates a breakdown of processing operations in one embodiment of the invention with a hybrid DBFN;

FIG. 8 shows a mesh configuration in one embodiment of the invention;

FIG. 9 illustrates the calculation of the direction vector of the UE;

FIG. 10 illustrates the calculation of the direction vector of the satellite;

FIG. 11 illustrates the projection of the direction vector into the reference frame of the satellite antenna.

Identical references may be used in different figures to designate identical or comparable elements.

### DETAILED DESCRIPTION

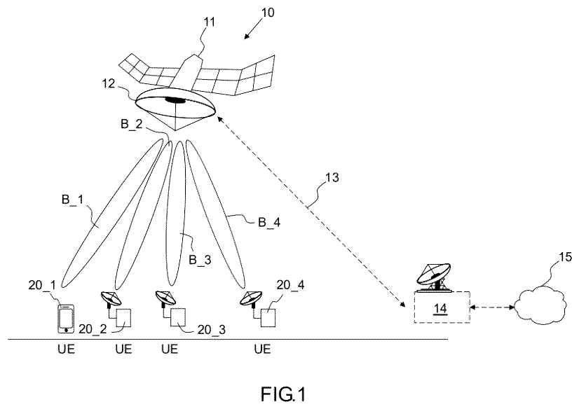

FIG. 1 is an illustration of a satellite telecommunication system 10 in one embodiment of the invention.

The satellite telecommunication system 10 comprises a plurality of user terminals (UE) 20_1, 20_2, . . . , 20_p, p strictly greater than 1 (4 UEs have been shown in FIG. 1), and a satellite platform 11.

Each UE comprises a satellite transmission and reception processing unit and a satellite transmission and reception antenna and is suitable for rendering satellite communications with the satellite 11 that are based on an MF-TDMA or OFDM waveform, for example. They may be of fixed terminal (example: 20_2) or mobile terminal (example: 20_1) type. Each UE 20_1, . . . , 20_p and the satellite 11 that overhangs it are in direct line of sight of each other.

The satellite platform 11 comprises a satellite antenna 12, for example MIMO, and a transmission and reception processing device. It is suitable for rendering satellite communications with the UEs 20_1, . . . , 20_p.

In some embodiments, the satellite telecommunication system 10 comprises a ground processing device 14 connected to the satellite platform 11 by way of a feeder link rendered by way of the antenna 12 (or by way of another antenna) of the platform 11 and a satellite antenna of the ground processing device 14. In these embodiments, the ground processing device 14 is suitable for performing processing operations for the satellite platform 11 that for example are computationally intensive or require a large storage volume (for example calculating the complex coefficients of the beamforming laws (weights) and/or modulating/demodulating symbols, and suchlike).

The telecommunications rendered between the satellite and each terminal UE are for example compliant with the 5G NR NTN standard (and for example Et NB-IoT/eMTC (IoT NTN)): data are interchanged between the satellite 11 and each UE, or 20_1, . . . , 20_p, so communicating by rendering a specific beam, or B_1, . . . , B_p, that is generated between the satellite and that UE and directed specifically towards that UE. There are therefore at least as many separate telecommunication beams as UEs communicating with the satellite at the time in question (because there are also beams used to convey the signaling channels). The frequency width of a beam is variable, one or more unit time-frequency resources being able to be allocated to a UE at a given time according to its needs. The satellite 11 is suitable for rendering beamforming techniques to generate these beams and is suitable for, in real time, automatically re-centering the beam on the targeted UE according to the updated position of that UE and the updated position of the satellite in the event of the latter moving. The payload data are transmitted on these beams in an encoded manner, in the form of OFDM symbols, using time-frequency resources that are specifically allocated to each UE, in the form of PRBs (Physical Resource Blocks) in the frequency domain and in the time domain, in the form of symbols and/or slots (the present invention applies to these specifically allocated resources; that said, it will be noted that in one embodiment there are also data in the network that are sent to all the UEs, for example on the physical broadcast channels, and the time-frequency resources allocated to these interchanges are not single-user).

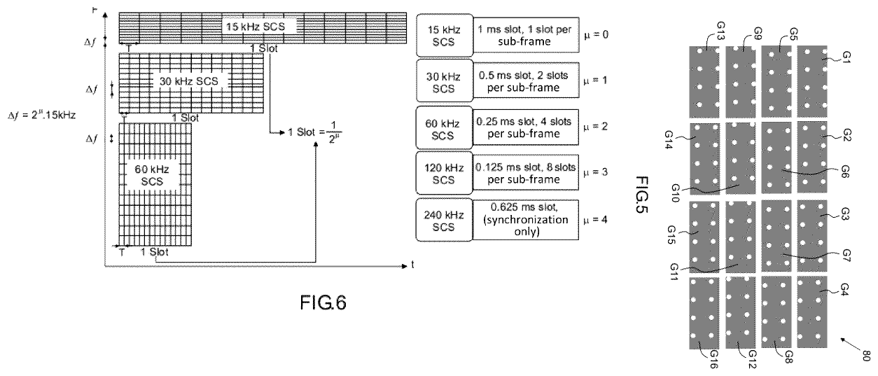

In a known manner and as shown in FIG. 6, a time slot comprises 14 successive OFDM symbols. A PRB corresponds to a block of 12 successive subcarriers. The spacing referenced Δf in FIG. 6 is equal to the SCS (Subcarrier Spacing) value.

When data are to be interchanged between the satellite 11 and a UE 20_i, time-frequency resources are specifically allocated to these interchanges, in a centralized and supervised manner, in order to control the level of interference between the beams.

A control unit 50, in the satellite platform 11, contributes to determining this allocation, in the manner indicated below. Over each allocation period, the allocated time-frequency resources are single-user.

The control unit 50 comprises a base 70 comprising the data for defining at least one set of grids, a PRB allocation unit 51 and a unit for estimating the location of UEs 52.

The complex coefficients of the beamforming laws for PRBs are calculated PRB by PRB, specifically for each OFDM symbol. The coefficient by which a PRB is multiplied is calculated in particular according to the location of the UE to which it has been allocated, the known position of the satellite and the center frequency associated with the PRB. Depending on the case, the coefficients are calculated locally in the satellite platform 11 or else in the ground processing device 14.

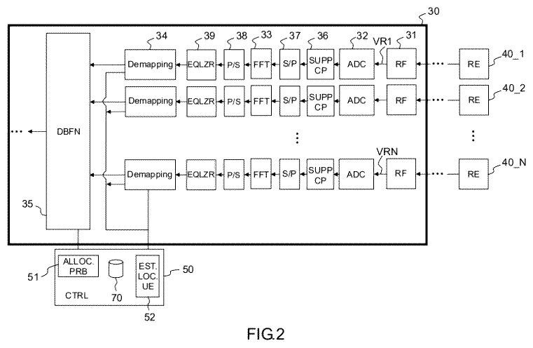

FIG. 2 diagrammatically shows part of the reception processing chain 30 of the satellite 11 of the satellite telecommunication system of FIG. 1 in one embodiment of the invention.

FIG. 3 diagrammatically shows part of the transmission processing chain 60 of the satellite of the satellite telecommunication system of FIG. 1 in one embodiment of the invention.

In a known manner, the indication of the PRBs to be used for interchanges between each UE and the satellite platform 11, during the next transmission (or reception) by them, is dynamically delivered by the control unit 50, for example to the gNB, and is then dynamically reported to the UEs (by way of control signals), and also to the reception and transmission processing chains 30 of the satellite platform, for example at least every T milliseconds, with T lying in the range <0 ms; 10 ms> for example).

Referring to FIG. 2, the reception processing chain is suitable for receiving, by way of radiating elements of the antenna 12 of the satellite platform 11, signals transmitted by a plurality of UEs.

The reception processing chain 30 comprises N parallel processing channels and is moreover connected to the control unit 50 of the satellite system 30.

According to the embodiments, the control unit 50 is aboard the satellite platform 11, or is on the ground, in the ground processing device 14, or its elements are distributed between the ground and the satellite platform. For example, the control unit is in the gNB/eNB.

The connection or connections between the reception processing chain and the control unit 50 are, depending on the case, wired (for example when the unit 50 is on board) and/or wireless (in particular if at least part of the unit 50 is on the ground).

The reception processing chain comprises in particular N parallel processing channels VRi, i=1 to N, each fed with the signal picked up by a respective radiating element (RE) 40_i of the satellite antenna 12.

Each processing channel VRi comprises:

a radio frequency RF unit 31 that is suitable for performing a frequency change to lower the frequency of the signal,

an analog-to-digital (ADC) converter unit 32 that digitizes the signal,

a CP (Cyclic Prefix) removal unit 36;

a serial-to-parallel (S/P) transposition unit 37;

an FFT unit 33 that is suitable for applying a fast Fourier transform to the signals received at the input, and is thus used to then work in the frequency domain, and in particular that is used to manipulate the complex coefficients transmitted on each subcarrier;

a parallel-to-serial (P/S) transposition unit 38;

an equalization unit (EQLZR) 39;

a demapping unit 34 that is suitable for filtering the PRBs according to the current allocation list of PRBs that has been supplied to it by the control unit 50, in order to transmit at the output of the demapping unit only the PRBs that are actually allocated to a UE; to that end, the demapping unit uses the indication of the PRBs to be used for interchanges between each UE and the satellite platform 11 dynamically determined by the control unit 50 (in one embodiment, the control unit 50 supplies the determined allocations to the gNB, which then actually allocates the resources according to these determined allocations).

a DBFN (Digital Beamforming Network) unit 35 is suitable for applying complex beamforming coefficients to the PRBs (indeed, the symbols transmitted on the PRBs allocated in terms of phase and amplitude are weighted) and, to that end, also uses the indication of the PRBs to be used (depending on each UE) for interchanges from each UE to the satellite platform 11 that is dynamically supplied by the control unit 50. This processing is used to selectively obtain all the symbols transmitted by the transmitting UE (and therefore by the receiving beam).

These sets of symbols at the output of the DBFN 35 are then modulated/demodulated (by way of the gNB function) according to the digital modulation performed, locally at the satellite platform 11 or by the ground processing unit 14, and according to the allocation information of the PRBs.

Referring now to FIG. 3, the transmission processing chain 60 is suitable for shaping and delivering to the radiating elements RE of the antenna 12 of the satellite platform 11 payload data intended for UEs among the UEs 20_1, . . . , 20_p.

The transmission processing chain 60 comprises the DBFN unit 35 and N parallel processing channels VE1, . . . , VEN.

The transmission processing chain 60 is moreover connected to the control unit 50 of the satellite system 30.

The DBFN unit 35 is suitable for applying complex beamforming coefficients to the symbols from the upstream coding chain that will then be transmitted on the PRBs allocated to this transmission, and, to that end, also uses the indication of the PRBs to be used, depending on each UE, for interchanges from the satellite platform 11 to the UEs that is dynamically supplied by the control unit 50.

The data at the output of the DBFN unit 35 are supplied to the input of each processing channel VEi, i=1 to N.

Each processing channel VEi comprises:

a serial-to-parallel (S/P) transposition unit 61;

an iFFT unit 62 that is suitable for applying the inverse of a fast Fourier transform to the signal received at the input from the DBFN 35, and is thus used to switch from the frequency domain to the time domain;

a parallel-to-serial (P/S) transposition unit 65;

a cyclic prefix (CP) insertion unit 66;

a digital-to-analog (DAC) converter unit 63 that converts the signal to analog;

a radio frequency RF unit 64 that is suitable for performing a frequency change (up-conversion) for the signal.

The signal at the output of the channel VEi, i=1 to N, is then delivered to a radiating element RE 60_i of the satellite antenna 12, for transmission.

The transmission by the radiating elements RE 60_1 to 60_N thus produces a plurality of radio communication beams, each beam, using the PRBs allocated to a UE, being dedicated to this UE alone and being selectively centered on this UE.

Thus, the allocation of time-frequency resources, in particular PRBs, in combination with intelligent beamforming, is a sensitive task that directly affects the quality of the signals interchanged, in particular the signal to interference ratio (C/I). It is therefore important to ensure that two proximate beams, for example beams B_1 and B_2, do not use identical PRBs on the same time resources (symbols/slots), which would give rise to levels of interference between the beams that would significantly degrade reception/demodulation throughput performance.

The invention thus proposes taking advantage of the knowledge of the location of the UEs and distributing them over a regular grid when appropriating PRBs, appropriation of PRBs on the same frequency being possible only for UEs that are sufficiently distant.

In one embodiment of the invention, a set 80 of grids is defined. The base 70 of the control unit 50 stores the data for defining the set 80 of grids.

In the case under consideration, the set 80 of grids comprises a plurality of grids, used as screens, for sorting the UEs to which the same PRB may be allocated.

Each grid represents the surface of the Earth that is visible from the satellite platform 11. Each grid point therefore corresponds to a position on the Earth's surface. Without this arrangement being mandatory, the point at the top left of each grid corresponds, for example, to the same point on the Earth at the corresponding end of the visible surface of the Earth, and the same reference frame is used for the various grids, and also the same scale.

Each grid comprises discrete non-contiguous areas, which will hereinafter be called “holes”. In one embodiment, the holes are arranged in a regular two-dimensional mesh configuration based on square cells (the holes corresponding to the vertices of the cells).

The pattern of arrangement of the holes on the grid is dependent on simple geometric criteria (minimum distance between UEs using the same PRB=distance between holes in a grid) and/or is dependent on beam patterns: the shape of the beams is not necessarily always regular especially if there is significant misalignment: the grid is then suitable for modifying/widening the mesh.

In the present case, the holes are circles, here all of the same size. The size of the hole (here the diameter of the circle) represents the hysteresis that is attached to the position of the UE that is potentially associated with this hole. Each hole corresponds to a portion of the Earth's surface.

In some embodiments, a hole has a shape other than a circle, for example a square or a triangle.

In one embodiment, the mesh configuration of holes is defined such that a beam directed at the center of the hole illuminates the entire hole satisfactorily (above a fixed minimum threshold) and two beams illuminating two neighboring holes do not overlap (by setting a maximum power threshold for the beam at the boundary of the hole it illuminates).

For example, the diameter of the circle corresponds to a distance of a few km to a few tens of km, for example between 0 km and 100 km, and the minimum distance between two neighboring holes corresponds to a distance for example between a few tens and a few hundreds of km, for example within the range [10 km; 900 km].

The shape of the holes and of the associated mesh configuration is dimensioned in such a way as to guarantee a certain level of isolation in terms of C/I between the beams that are likely to point at the holes of the mesh configuration. This dimensioning will take into account the pattern of formation of the beams that are able to be generated using the satellite antenna 12 and also the power allocation produced by the satellite between the beams that are served. Referring to FIG. 5, a portion of each grid G1, . . . , G16 (the portions corresponding to the same portion of the Earth's surface) is shown: the holes are shown in white, the rest of the grid portion in gray.

In one embodiment, in the various grids G1 to G16, the mesh configuration of the points is the same, but offset, i.e. arranged differently on the grid each time.

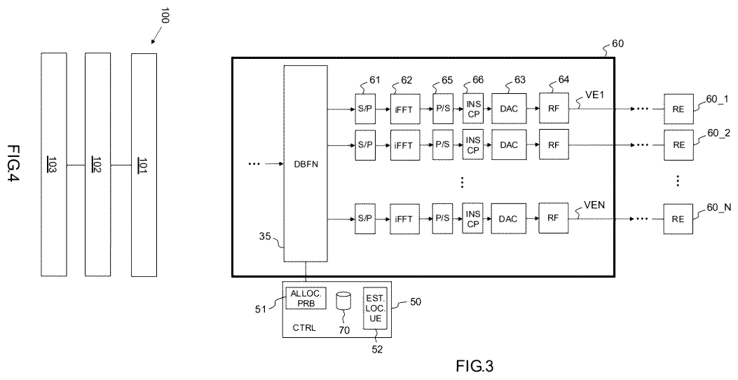

Referring to FIG. 4, in one embodiment, the control unit 50, which comprises the PRB allocation unit 51, the unit for estimating the location of UEs 52 and the base 70 of the set of grids, is suitable for rendering the steps of a method for allocating PRBs 100 for the next time interval under consideration (i.e. for one or more slots) according to the invention.

Thus, in a step 101, among all the UEs to be served in the coverage, the UEs to be served simultaneously on the next slot are identified and the unit for estimating the location of UEs 52 obtains the location of the UEs of the system 10 that are visible from the satellite platform 11.

In a step 102, the PRB allocation unit 51 determines the allocation of PRBs per UE visible from the satellite platform 11 according to the location of the UEs, the allocation of PRBs per UE defining the PRBs to be used for the next time interval under consideration (excluding those that are unallocated) for transmitting and receiving data between that UE and the satellite platform.

Each grid Gi, i=1 to 16, from the set of grids 80 has an associated PRB (or an associated set of PRBs). The same PRB (or set of PRBs) cannot be associated with two separate grids from the set of grids 80. Separate PRBs (or sets of PRBs) may be independently associated with the same grid (i.e. without being part of a set of PRBs collectively allocated to a UE); these grids are then considered to be two separate grids in the remainder of step 102.

PRB resources are allocated according to the following rule:

The same PRB associated with a grid can be allocated to each of multiple UEs only if the UEs appear in separate holes of the grid (i.e. the PRB cannot be allocated to two or more UEs that would be in the same hole; and the PRB cannot be allocated to a UE that does not appear in a hole).

There are multiple ways to determine how to couple PRBs to grids in step 102, following this rule:

According to specified geometric criteria, the PRB allocation unit 51 associates UEs with holes in the grids, ensuring that a UE is ultimately associated with only one grid and only one hole in that grid. There may be multiple UEs in the same hole of the same grid. It selects the UEs that are allowed to transmit/receive simultaneously in the next time interval. To that end, it can take into account one or more criteria, in particular:

traffic demand and/or

minimization of the number of grids associated with the selected UEs (minimizing the number of different grids maximizes reuse of the spectrum and thus maximizes capacity).

The PRB allocation unit 51 then allocates one or more PRBs first for each grid associated with the selected UEs and then for each UE selected and associated with this grid according to the following rules and the constraints on traffic demand:

PRBs allocated to different grids must be different.

UEs that are in the same hole of the same grid must have different PRBs.

For example, the process rendered in step 102 is as follows to select the UEs allowed to transmit/receive simultaneously in the next time interval; for example, a criterion for minimizing the number of different grids associated with the selected groups of UEs will also be taken into account (minimizing the number of different grids maximizes reuse of the spectrum and thus maximizes capacity): for each UE considered successively:
in a sub-step 102_1, the PRB allocation unit 51 determines, according to the location obtained in step 101, those grid holes among the grid holes remaining to be selected in which the UE is situated (i.e. the grid hole corresponding to the portion of the Earth's surface in which the UE is situated), and selects, among them, the hole of the grid whose center is closest to the UE;
in a sub-step 102_2, the hole thus selected in step 102_1 is removed from the set of grid holes remaining to be selected;
in a sub-step 102_3: the sub-steps 102_1 and 102_2 are iterated as long as PRBs remain to be allocated to the UE under consideration; then
sub-steps 102_1 to 102_3 are then carried out for the next UE under consideration.

A PRB or a set of PRBs that are exclusive to the grid is associated for each grid according to the traffic demand associated with the UEs (those with the most demand) on each of the grids. The PRB associated with the grid is then allocated to each UE associated with the grid; or when a set of multiple PRBs has been associated with the grid, the PRBs among the set of exclusive PRBs for each UE associated with the same grid are allocated according to the volume of traffic demand of that UE: for example, considering the PRBs denominated PRB1, PRB2 and PRB3 associated with a grid, which is itself associated with three terminals UE1, UE2, UE3 corresponding to respective demand volumes V1, V2, V3, with V1<V2<V3, PRB1 will be allocated to each of UE1, UE2, UE3, for example, PRB2 will be allocated to UE2 and UE3, and PRB3 will be allocated to UE3.

In one embodiment, PRBs are allocated between the grids according to the location of the UE, its associated grid and an overview of the association between the grids and UEs served simultaneously.

Finally, in a step 103, the allocation thus defined for the next interchanges is delivered by the control unit 50 to the various elements of the network 10 that need to make use of this allocation: the gNB, the transmission and reception processing chains of the satellite 30, 60, the visible UEs.

Steps 101 to 103 are then repeated to determine the allocation of the next time interval (for example every T milliseconds).

Each grid associated with a PRB (or a set of PRBs) thus has an associated group of UEs to which the PRB (or at least one PRB from the set of PRBs) has been allocated. In one embodiment, for each UE, the grid that is prioritized is the one that comprises the hole to which the UE is closest (for example the one that comprises the hole whose center is positioned at the shortest distance from the UE).

In one embodiment, in step 102, if, after step 102 has been rendered (1st pass), there remain PRBs to be allocated and UEs that have not received the necessary allocation, which means that the constraints imposed by the grid pattern can no longer be met, step 102 is rendered again (2nd pass) for the PRBs still to be allocated relative to the UEs still to be served by considering another set of grid(s). Each grid from this other set of grid(s) has holes that are closer to each other than the grids from the set 80 of grids (poorer C/I). Other passes may be implemented with other sets of grids that are successively more “close-fitting” until the resources are exhausted or a C/I that is known to be too degraded is reached.

In one (degraded) embodiment, there are points on the surface of the Earth covered by the satellite platform that are outside all the holes of all the grids. In such a case, the hole of the grid that is closest to one of these points will be allocated to said point.

In one embodiment, the location of each UE in step 101 is obtained by the location estimation unit 52 according to one or more locations of the UE among:
a location of the UE supplied by the UE itself (for example by the GPS of the UE or for example a location derived from the GNSS receiver of the UE);
a location of the UE directly or indirectly supplied by the gNB function in the ground processing device 14 (for example by way of Channel State Information (CSI) information);
a location of the UE determined according to an estimate of the direction of arrival (DOA), at the satellite antenna 12, of the signal from each UE.

Sounding signals (SRS) transmitted by the UEs and received by the satellite platform 11 are known: in accordance with the 5G NR standard, these signals are known in advance and customized for each user. Regular measurements of these signals are carried out, in accordance with the 5G NR standard, for the reception chain of the satellite. Application of an LMS (Least Mean Square) algorithm is used to update the value of the beamforming weights associated with each radiating element of the antenna so as to maximize the signal-to-noise ratio of the received SRS signals. The newly obtained beamforming laws thus are used to estimate the direction of arrival of these very signals from the UE and suchlike. This updating is performed, according to the embodiments, in the satellite platform 10 or in the ground processing device 14 (and in the latter case the necessary data are interchanged on the feeder 13).

In one embodiment of the invention, in step 101, the location estimation unit 52 (which, as seen above, is located in the satellite platform 11 or in the ground processing device 14 and then interchanges data with the satellite platform 11 by way of the feeder 13) applies an LMS (Least Mean Square) algorithm making it possible to determine the value of the beamforming weights associated with each radiating element of the antenna maximizing the power of the sounding signals (received SRS signals). These newly obtained beamforming laws are then used to estimate the direction of arrival of these very signals from the UE: the estimation unit 52 then applies a non-linear regression making it possible to find, on the basis of the recently determined weights, the direction of arrival (DOA) in terms of elevation and azimuth.

These aspects are now clarified.

Courtesy of the satellite 11 and the center of the position of the directed cell, the direction of the beam is calculated and applied to the beam by the DBFN (Digital Beam Forming Network).

The center of the cell direction vector is considered to be the origin; reference 80 indicates the center of the Earth.

The direction with regard to the normal of the DRA panel of the antenna is used to determine the phase laws to be applied to form the beam that will light the cell.

Referring to FIGS. 1, 2 and 3, we have:

\vec{d_{UE}}=(Pₓ^{UE}−Pₓ^{SAT}, P_{y}^{UE}−P_{y}^{SAT}, P_{z}^{UE}−P_{z}^{SAT})

\vec{d_{SAT}}is the direction of the normal of the antenna with regard to a center-of-the-Earth reference frame, such as \vec{d_{UE}}.

As in the case of beam formation, the important thing is the direction \vec{d} with regard to the normal of the antenna; it is necessary to put the vector \vec{d_{UE}}in the reference frame of the satellite antenna.

Thus, \vec{d}=\vec{d_{UE}}−\vec{d_{SAT}}.

First, two angles from the normal of the antenna must be determined:
α, which is the angle between the normal of the antenna (z-axis) and the projection of \vec{d} onto the plane (xy) called proj\vec{d}_{xy}, or the azimuth;
β, which is the angle between the normal of the antenna (z-axis) and the projection of \vec{d} onto the plane (yz) called proj\vec{d}_{yz}, or the elevation.

Courtesy of these two angles, it is then possible to calculate the direction angles of a rectangular antenna using the following algorithm.
Let S be the distance between the center of the consecutive radiating elements in the two axes of the antenna (x and y).
Let Nₓ^{RE} be the number of radiating elements in the x-axis.
Let N_{y}^{RE} be the number of radiating elements in the y-axis.
Let λ be the wavelength of the signal to be formed.

The weights are calculated as follows:
for kₓ=0 to Nₓ^{RE}−1
for k_{y}=0 to N_{y}^{RE}−1
   dₓ=kₓ·S·sin(α)
   d_{y}=k_{y}·S·sin(β)
   d=\sqrt{dₓ²+d_{y}²}
   W_{x,y}=e^{-2πd.i/λ}

This allows the weights to be calculated from known angles.

Having said this, let us now consider the reverse path, that is to say how to find α and β0 from W_{xy}: this is where the aforementioned regression comes in. Let W_{x,y}^{tg} be the set of weights for each radiating element for which α^{tg} and β^{tg} are to be found. Regression is used to find α^{tg} and β^{tg}, allowing the squared error to be minimized, that is to say Σ_{x,y}|W_{x,y}^{tg}−W_{x,y}| to be minimized.

Regression can be performed using various algorithms well known to those skilled in the art, for example non-linear regression or the gradient algorithm. In all cases, the objective of these algorithms is to find α^{tg} and β^{tg}, which minimizes the squared error. This allows the vector \vec{d} to be determined, and then knowing \vec{d_{SAT}}, which is provided by the satellite platform that controls the attitude of the satellite, \vec{d_{UE}}is then determined according to d_{SAT} and \vec{d}.

The location estimation unit 52 then determines the position of a UE to be the intersection of the Earth's surface and the DOA thus estimated.

It will be noted that the evaluation of the DOA and/or the location of a UE as described above on the basis of the updated beamforming weights may be rendered independently of any use of the DOA or location in the allocation of PRBs.

The invention has been described above in a particular embodiment, with particular reference to the 5G NR NTN standard. It is of course applicable to other technologies allocating, for example, time-frequency resources OFDM, FO based on OFDM, but also DVB RCS2, MF-TDMA, and suchlike.

In the embodiment below, the allocation has been described with reference to a satellite. In another embodiment, the allocation according to the invention is rendered for a satellite constellation comprising multiple satellites, in order to avoid interference also between telecommunications employing various satellites of the constellation.

The method described may be rendered by executing software instructions on a processor. Alternatively, it may be rendered by dedicated hardware, typically a digital integrated circuit, either specific (ASIC) or based on programmable logic (for example FPGA/Field Programmable Gate Array).

According to the embodiments, the control unit is located on the ground (for example in the device 14) or in the satellite platform 11.

For example, the prior art architecture of a transparent satellite is modified to include this RU function instead of the DTP (Digital Transparent Processor) in the satellite platform 11. The payload then becomes regenerative and the feeder link 13 then transports the samples in the frequency domain in line with the functional split between the RU on board and the DU (Distributed Unit) on the ground. A good compromise is, for example, a 7.3 split on the downlink DL and a 7.2 split on the uplink UL, which allows onboard complexity to be limited while limiting overheads on the feeder 13.

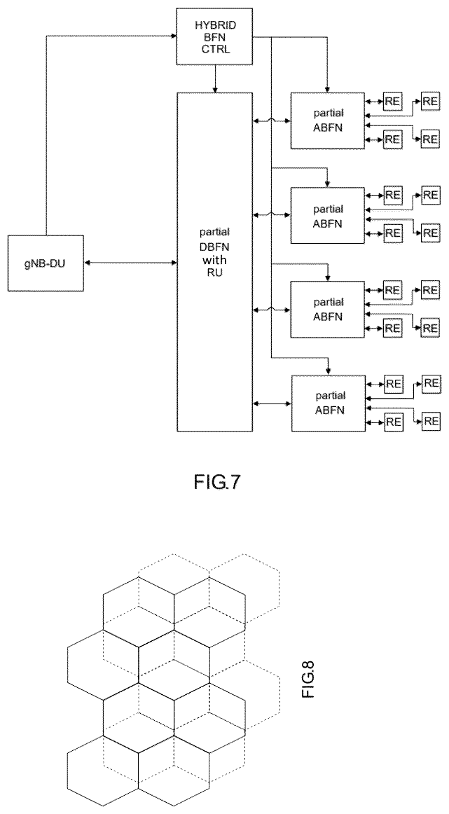

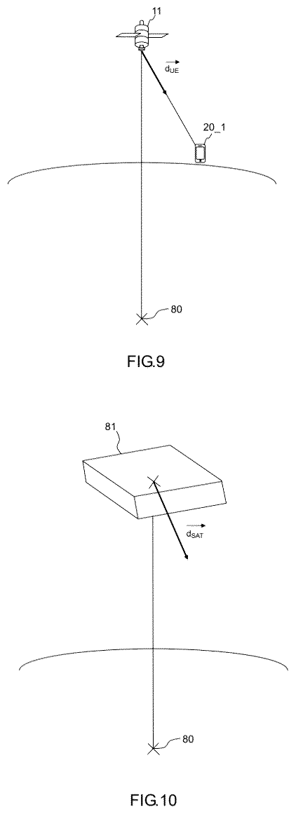

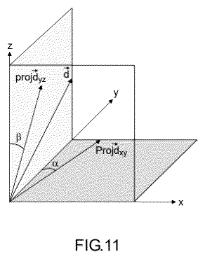

Some types of satellites do not have digital beamformers: large satellites with MFPB (Multi-Feed per Beam) formers at the output of the TWTAs, for example, or satellites with ABFN beamformers (Ka constellations, for example). An approach proposed in millimeter bands is used to maintain a certain agility while limiting consumption by employing ABFNs, shown diagrammatically in FIG. 7. Overall, ABFNs are used to assemble a subset of the radiating elements into sub-panels delivering one or two beams. These sub-beams on each sub-panel are then put together by a DBFN allowing the number of beams to be increased. This hybrid approach allows the invention to be rendered even on payloads that do not implement a pure DBFN.

In the case of an MFPB-based VHTS satellite solution, the invention is used, for example, to shift the mesh of the beams to allow them to be re-centered on the users to be served and to “plug” the areas between the beams that have roll-offs between 3 and 6 dB, depending on the layout: cf. FIG. 8, which, compared with the grids of FIG. 5, corresponds to hexagon-shaped holes. In FIG. 8, a representation of two grids (one in solid lines and the other in dotted lines) can be seen.

1. A method for allocating time-frequency telecommunication resources in a wireless satellite telecommunication system,
said satellite telecommunication system comprising a satellite, user terminals UE (20_1, 20_2), the satellite being suitable for simultaneously rendering multiple telecommunication beams (B_1, B_2) that are each associated, at a given time, with a separate user terminal UE (20_1, 20_2) and for dynamically re-centering each beam on the UE associated with said beam;
each telecommunication beam (B_1, B_2) being established according to time-frequency resources selectively allocated to the associated UE (20_1, 20_2);
said method being comprising the following steps rendered by an electronic resource allocation unit:
obtaining the position of each UE (20_1, 20_2);
given a set of grids (G1, G2) each representing at least a portion of the Earth's surface and each comprising a plurality of non-contiguous areas distributed in the grid, the distance between any two areas of a grid being above a determined non-zero threshold associated with the grid, the time-frequency resources are allocated relative to a time T by applying at least the following rule, at least the same time-frequency resource being associated with the grid beforehand: said time-frequency resource associated with the grid may be allocated to each of 2 UEs (20_1, 20_2) only if the obtained positions of said 2 UEs are in separate areas from said plurality of non-contiguous areas distributed in the grid.

2. The time-frequency resource allocation method according to claim 1, wherein if, during a first step of allocating time-frequency resources using said set of grids (G1, G2) that are each associated with a first determined threshold, it has not been possible to allocate time-frequency resources to at least one UE (20_1, 20_2) in accordance with the rule, an additional allocation step is performed using at least one set of additional grid(s) representing at least said portion of the Earth's surface and each comprising a plurality of non-contiguous areas distributed in the grid, the distance between any two areas of a grid being above a second determined non-zero threshold associated with the grid, which is below the first threshold.

3. The time-frequency resource allocation method according to claim 1, wherein the time-frequency resources are allocated, relative to a time T, by moreover applying at least the following rule:
given a first grid (G1), or a second grid (G2) separate from the first grid, from the set of grids associated with a first time-frequency resource, or a second time-frequency resource separate from the first time-frequency resource: when a UE (20_1, 20_2) is determined as being located in both a first area from said plurality of non-contiguous areas distributed in the first grid and a second area from said plurality of non-contiguous areas distributed in the second grid, it is determined whether the UE is closer to the center of the first area or to the center of the second area; and if the UE is determined as being closer to the center of the first area, or the second area, the first time-frequency resource, or the second time-frequency resource, is allocated thereto.

4. The time-frequency resource allocation method according to claim 1, wherein the position of a UE (20_1, 20_2) is obtained by rendering the following steps:
calculating values of the beamforming weights maximizing the power of predefined signals received from a UE;
estimating the direction of arrival, referred to as DOA, of a signal from a UE according to said beamforming weights determined for the UE by applying a regression algorithm linking beamforming weights and DOAs;
determining the position of the UE according to at least the intersection of the Earth's surface and the estimated DOA.

5. A computer program intended to be stored in the memory of an electronic unit for allocating resources in a wireless satellite telecommunication system comprising a satellite, user terminals UE (20_1, 20_2), the satellite simultaneously rendering multiple telecommunication beams (B_1, B_2) that are each associated with a separate user (20_1, 20_2) and dynamically re-centering each beam on the associated UE;
each telecommunication beam (B_1, B_2) being established according to time-frequency resources selectively allocated to the associated UE (20_1, 20_2); said time-frequency resource allocation unit moreover comprising a microcomputer;
said computer program comprising instructions that, when executed on the microcomputer, render the steps of a method according to claim 1.

6. A device for allocating time-frequency telecommunication resources for a wireless satellite telecommunication system,
said satellite telecommunication system comprising a satellite, user terminals UE (20_1, 20_2), the satellite being suitable for simultaneously rendering multiple telecommunication beams (B_1, B_2) that are each associated, at a given time, with a separate user terminal UE (20_1, 20_2) and for dynamically re-centering each beam on the UE associated with said beam;
each telecommunication beam (B_1, B_2) being established according to time-frequency resources selectively allocated to the associated UE (20_1, 20_2);
said resource allocation device being wherein it is suitable for obtaining the position of each UE (20_1, 20_2) and, given a set of grids (G1, G2) each representing at least a portion of the Earth's surface and each comprising a plurality of non-contiguous areas distributed in the grid, the distance between any two areas of a grid being above a determined non-zero threshold associated with the grid, for allocating the time-frequency resources relative to a time T by applying at least the following rule, at least the same time-frequency resource being associated with the grid beforehand: said time-frequency resource associated with the grid may be allocated to each of 2 UEs (20_1, 20_2) only if the obtained positions of said 2 UEs are in separate areas from said plurality of non-contiguous areas distributed in the grid.

7. The time-frequency resource allocation device according to claim 6, suitable for, if, during a first step of allocating time-frequency resources using said set of grids (G1, G2) that are each associated with a first determined threshold, it has not been able to allocate time-frequency resources to at least one UE (20_1, 20_2) in accordance with the rule, performing an additional allocation step using at least one set of additional grid(s) representing at least said portion of the Earth's surface and each comprising a plurality of non-contiguous areas distributed in the grid, the distance between any two areas from said plurality of areas of a grid being above a second determined non-zero threshold associated with the grid, which is below the first threshold.

8. A time-frequency resource allocation apparatus according to claim 6, suitable for allocating the time-frequency resources relative to a time T by moreover applying at least the following rule:
given a first grid (G1), or a second grid (G2) separate from the first grid, from the set of grids associated with a first time-frequency resource, or a second time-frequency resource separate from the first time-frequency resource: when a UE (20_1, 20_2) is determined as being located in both a first area from said plurality of non-contiguous areas distributed in the first grid and a second area from said plurality of non-contiguous areas distributed in the second grid, it is determined whether the UE is closer to the center of the first area or to the center of the second area; and if the UE is determined as being closer to the center of the first area, or the second area, the first time-frequency resource, or the second time-frequency resource, is allocated thereto.

9. The time-frequency resource allocation device according to claim 6, suitable for obtaining the position of a UE (20_1, 20_2) by calculating values of the beamforming weights maximizing the power of predefined signals received from a UE, and then by estimating the direction of arrival, referred to as DOA, of a signal from a UE according to said beamforming weights determined for the UE by applying a regression algorithm linking beamforming weights and DOAs and by determining the position of the UE according to at least the intersection of the Earth's surface and the estimated DOA.
